(19) United States
(12) Patent Application Publication
(10) Pub. No.: US 2026/0022986 A1
(43) Pub. Date: Jan. 22, 2026

(54) CRACK DETECTOR AND MONITORING SYSTEM

(71) Applicant: IPR INNOVATIVE PRODUCTS RESOURCES INC., Québec (CA)

(72) Inventor: Paul D OKULOV, Québec (CA)

(73) Assignee: IPR INNOVATIVE PRODUCTS RESOURCES INC., Québec (CA)

(21) Appl. No.: 18/993,359

(22) PCT Filed: Jul. 11, 2023
(86) PCT No.: PCT/CA2023/050928

§ 371 Date: Jan. 10, 2025

Related U.S. Application Data
(60) Provisional application No. 63/368,066, filed on Jul. 11, 2022.

(51) Int. Cl. G01M 5/00

(52) U.S. Cl. CPC G01M 5/0033

(57) ABSTRACT

The present invention relates to the methods and devices for crack detection and monitoring a material subject of a potential crack, delamination or debonding affecting the material in aircrafts, infrastructures, machinery, vessels, hermetic enclosures, and other applications. The crack detector comprises a base defining at least one sealed volume formed between the material subject of a potential crack in said material and the base, wherein the at least one said sealed volume is filled with a first fluid, and, at least one first sensing means in communication with said at least one sealed volume. The at least one first sensing means measures a change in at least one physical or chemical parameter of the first fluid for detecting the presence of a crack.

### TECHNICAL FIELD

The present invention relates to the methods and devices for crack detection and monitoring a material subject of a potential crack affecting the material in aircrafts, infrastructures, machinery, vessels, hermetic enclosures, and other applications.

### DESCRIPTION OF RELATED ART

Fatigue cracks in a material are of tremendous concern as they can cause catastrophic failure of any mechanical system or an individual component. Significant amounts of efforts and time are spent on non-destructive inspection and, generally speaking, finding a crack is often as difficult as finding a needle in a haystack.

Although cracks are not desired, a mere presence of a crack does not mean that the material with crack cannot bear loads and thus significant efforts are also spent on monitoring the crack size. That effort is accompanied with necessity of physically getting to the crack site. For instance, in aircraft, the necessity of more frequent inspections of the parts with cracks requires careful removing of the equipment and getting to the crack site, as well as reassembling the equipment, which also presents an additional risk and is expensive.

Fast growing industries, like electric vehicles employing banks of batteries also suffer from potential liability related to unnoticed cracks in enclosures containing the batteries, wherein if an enclosure is cracked, harmful chemicals can escape.

Majority of known methods and devices for crack detection are: electric (Acoustic, Magnetic, Radio frequencies, Nuclear, Infra-red imaging), Penetrants (dyed liquids), Visual, and Continuous Vacuum Monitoring (CVM), as shown in FIGS. 1 to 3.

Apart from methods available for detection of cracks stands the predictive methodology (Autonomous Structural Health Monitor by Okulov, U.S. Pat. No. 10,663,357). However, any predictive methodology used as a stand-alone approach suffers from the uncertainty of the prediction itself due to very high scattering of the crack appearance time (or cycles' wise) and high variability of crack growth rate.

Disadvantages being encountered by the majority of industries by using existing methods include, but not limited to: i). inspections can not be conducted during operation of an aircraft or a machinery; ii). no simple autonomous crack indicator capable of working in real life conditions is known; and iii). acoustic methods for crack detection are difficult to operate during flight or machinery operation due to significant acoustic noise making crack detection more difficult and less precise.

Infra-red (IR) cameras used for detecting the early stages of cracks formation and their progression are extremely useful in laboratory conditions, however, in real life operation, where parts are experiencing high gradient of the temperature change within short periods of time (an airplane gaining altitude is one of the examples), the detection becomes more difficult. The fixed nature of the viewing angle of the IR camera also requires it to be positioned at a fair distance from the part, which, in case of an aircraft, is not always achievable.

Real time methods also include crack propagation sensing resistive gauges comprising an array of brittle electro-conductive circuits applied to the surface; however, they typically cover small areas of the material surface and are usually used in places where the position of the potential crack is already known. They also have a disadvantage of providing false results when the material works primarily in compression and the electro-conductive elements of the gauge can simply close and regain conductivity after the breakage.

It is desirable to have a portable, autonomous, remotely accessible and low power consuming device, which can positively identify a crack during operation (flight, for instance), and provide for continuous monitoring of the crack and its propagation regardless of the state of the loading (tension tends to open the crack and compression assists in closing it).

Such a device has to be robust, have broad temperature range of operation, extremely low power consumption and in some instances comprise a passive indicator (visual, for instance) of a crack.

Ideally, such a device can identify the position of the crack and be optically transparent for assisting the crack visual inspection after its identification.

### BRIEF SUMMARY OF THE INVENTION

According to one aspect of the present invention, it provides means for providing a sealed volume, a cell or a channel sealed over the material. Such volume becomes a miniature, isolated “environmental eco-system” where such parameters as pressure, relative humidity, and presence of specific gases or chemicals remain in balance unless the volume becomes connected to another environment via a passage, provided by the crack.

One solution is based on the principle of communicating vessels equalizing or “exchanging” physical or chemical properties of the fluids filling said vessels or said fluids interacting or reacting with each other and producing a visible/optical or electrically detectable indicator of the condition when such communication is prohibited (no crack) or the communication is enabled (presence of a crack).

For instance, Oxygen (O), Carbon Dioxide (CO₂) or Nitrogen (N), water vapor or moisture (H₂O) as well as any other gas present in the surrounding environment (ambient atmosphere) diffuses inside any sealed volume (vessel's interior) initially containing a lesser concentration of a gas or vapor (compared to its concentration in the ambient atmosphere) via the passage provided by a crack. The presence of such component can change the color of an indicator sensitive to it. Indicators or sensors sensitive to said Oxygen, Carbon Dioxide or Nitrogen are readily available.

Another example is using moisture or humidity present in ambient atmosphere to activate an indicator or change the readings of the sensor (relative humidity, for instance) connected to said sealed cell or volume. In this case, a cell comprising the volume hermetically sealed on the surface of a material can contain an amount or a “pixel” of a moisture-sensitive indicator that changes its color in the presence of moisture. Additional positive effect can be achieved by positioning of a small amount of a moisture absorbing material capable of absorbing the initial amount of moisture trapped in the cell during installation process and remaining there after the installation. If moist air can pass to the cell from the ambient environment (or an adjacent volume filled, say with water solution), the moisture absorption process of said small amount of absorbent will achieve saturation stage and then the moisture indicator will turn into a different color, indicating presence and the location of the crack.

An absorbing means positioned within the volume can also facilitate inflow of the gases from the outside of the cell by changing partial gas pressure inside the cell, thus providing for a reliable operation of the indicator film in the presence of a crack. Another advantageous effect of using an absorbent is to alleviate the effect of the very slow penetration of, say, moisture, via an imperfectness of the seal of the volume and assist in maintaining low amount of moisture and uniform “readings” of the indicators, while the larger opening provided by the crack will eventually cause the absorbent to saturate and the incoming moisture will change the color of the indicator.

Chemical indicators including pH, quality criterion index, kinetics, oxidation-reduction potential, reactive carbon, total organic C, total residues, dissolved oxygen (DO), chemical oxygen demand (COD), biological oxygen demand (BOD), phosphate (P), nitrogen (N₂), anhydrous ammonia (NH₃), nitrate (NO₃), and copper (Cu²⁺) can serve as indicators of a crack if the indicator is positioned in a closed hermetic volume or cell wherein the hermetic seal interrupted by the crack can lead to its detection.

It should be understood that the size of the cell or volume can be as small as technically possible and the cells can be organised in a lattice covering the area of interest where an individual cell will serve as a visual pixel of a displaying system.

Luminescent effect of some indicators can be also utilised to assist in signifying the position of a crack by using black light, for instance.

Another option is to provide a sensing cell with electrodes and provide an adjacent cell with electrolyte or ionized gas. When the crack is present, it provides an exchange between said cells, sensing electrodes will be able to pass electric current between them. Electrical conductivity can be also achieved via exposure of a pair of electrodes to acidic or alkaline wetting provided by absorbing substrate the electrodes are attached to.

Similar concept can be achieved for remote monitoring or a crack. In this case, an individual cell, a channel or a volume hermetically sealed over the surface of a material can have sensing means communicating with an MCU or a processor. In such a variant the sensing means can include a pressure sensor, relative humidity sensor, gas detector or any suitable sensor, which can detect change in the state of the fluid inside the cell (when a crack opens a passage to the surrounding atmosphere or to another cell filled with fluid).

Such device can be passive and relay on natural variations of, say, barometric pressure or relative humidity of the atmosphere outside of the sensing cell (thus monitoring the “conditions” inside the cell only) or, it can have a physical or chemical condition “exciter”. One example of such an excitation device is use of a pressure sensor connected or integral with the inner cell volume and elevating the temperature of the fluid inside said sensing cell, thus provoking the increase in pressure inside the cell. If the seal remains hermetic (no crack), then the response of the pressure sensing means will be closely correlated with the nature of the excitation. If a crack is present and the hermetic seal is interrupted, the response or pressure readings will have less significant correlation with the excitation.

Such an “exciter” can work on the principle of changing any of the detectable parameters of the fluid, i.e., it can change the temperature, physical size of the volume, partial pressure of a gas contained in the cell and any other condition that may lead to either one response correlated with “no-crack situation” and another response correlated with “crack present” situation. By analysing the level of such correlation, a relative size of the crack can be estimated.

The present invention provides for a simple and reliable solution for detection and monitoring of a crack. It is not prone to any interference from acoustic, vibrational, electrical, RF or other sources of noises and thus can be used for live crack detection and monitoring. The device can be produced in a form of a pressure sensitive label or a patch containing either individual cells, channels, volumes or lattices and patterns of such, each representing a closed volume hermetically sealed on or around the surface of the material. Such label equipped with passive indicators or electronically monitored sensing means can be produced inexpensively and deployed in great numbers.

According to one aspect of the present invention, it provides a crack detector for a material, comprising a base defining at least one sealed volume formed between the material subject of a potential crack in said material and the base, wherein the at least one said sealed volume is filled with a first fluid, and, at least one first sensing means in communication with said at least one sealed volume. The at least one first sensing means measures a change in at least one physical or chemical parameter of the first fluid for detecting the presence of a crack.

The crack detector may further comprise a comparator for comparing said change in the said at least one physical or chemical parameter of the first fluid with a characterized physical or chemical parameter of said first fluid.

The characterized parameter of said first fluid may be anticipated, predicted, measured or calculated.

The at least one sealed volume may be surrounded by a second fluid.

The crack detector may further comprise at least one second sensing means measuring at least one physical or chemical parameter of said second fluid.

The crack detector may further comprise a means for inducing or changing a physical or chemical parameter of said first fluid in order to promote a change and observe a correlation between said at least one parameter and anticipated, measured or calculated parameter of said first fluid.

The first fluid is gas or liquid; and the second fluid may be gas or liquid.

The at least one first sensing means may be configured to measure one or more of parameters selected from the group consisting of pressure, temperature, mass, chemical composition, presence or absence of a chemical substance or a gas, color, humidity or relative humidity, and any optical or electric property of said first fluid; wherein said electric property is selected from the group consisting of dielectric constant, resistance and capacitance.

The second sensing means may be configured to measure one or more parameters selected from the group consisting of pressure, temperature, mass, chemical composition, presence or absence of a chemical substance or a gas, color, humidity or relative humidity, and any optical or electric property of said first fluid; wherein said electric property is selected from the group consisting of dielectric constant, resistance and capacitance.

The first sensing means may be configured to detect a chemical reaction, diffusion or dilution in said first or second fluid caused by said fluids becoming in contact with each other.

The crack detector may further comprise means for changing the amount of any component of said first fluid.

The means for inducing or changing a physical or chemical parameter of said first fluid may be changing its pressure and is selected from the group consisting of a heater and a cooler.

The means for changing pressure of the first fluid may further comprise volume changing means by bending a diaphragm, moving a piston or deforming said volume itself.

The means may include an absorbing material for reduction of the presence of a predetermined gas or liquid.

The at least one sealed volume may further comprise a plurality of compartments embedded in a sheet may comprise transparent sections at least over said sealed volumes or compartments and wherein said plurality of compartments contain a visual indicator of presence or absence of said second fluid.

The at least one sealed volume may further comprise a plurality of compartments embedded in a sheet comprising said at least one first sensing means to detect said second fluid entering said sealed volume or said first fluid exiting from said sealed volume.

The sealed volumes may further comprise a plurality of compartments arranged in a matrix, pattern or lattice spread over said material.

### BRIEF DESCRIPTION OF DRAWINGS

The present invention will now be described in more detail with reference to the accompanying drawings, in which:

FIGS. 1 to 3 illustrate conceptual/perspective views of the prior art, which is generally known as Comparative Vacuum Monitoring system;

FIG. 4 shows a first exemplary embodiment of crack detector of the present invention, where the crack detector contains a pressure sensor monitoring a volume in a closed channel with an exciter, and a crack cause breaks in the sealed volume and being in communication with atmosphere;

FIG. 5 illustrates the same system where a crack connects the volume and channel with another sealed volume;

FIG. 6a) shows a graph, where the plots of atmospheric pressure (ASP) against time in comparison with the reading of the pressure sensor (or PS) positioned in a sealed volume when no crack breaking the sealed volume;

FIG. 6b) shows a graph, representing the correlation between readings of the APS and PS sensing means when there is no crack;

FIGS. 7a) and 7b) show graphs under similar conditions as per FIGS. 6a) and 6b), respectively, but with a crack present;

FIGS. 8 to 17 illustrate different methods or devices for changing or excitation of the condition within the sealed volume;

FIG. 18 and FIG. 19 show a third crack detector of the present invention with resistive heating element;

FIGS. 20 to 23 illustrate different arrangements for forming sealed volumes or cells;

FIGS. 24 to 27 further illustrate lattices or patterns of the sealed volumes providing for detection of not only presence of a crack but also its relative position either via visualisation using an indicator or for remote monitoring using sensing means, MCU, and interface (not shown) to assure autonomous monitoring using available electronic means;

FIG. 28 presents a fourth exemplary embodiment of a crack detector where two pressure sensing means PS1 and PS2 are used to compare the measured conditions in the adjacent volumes;

FIG. 29 shows a graph showing measured data from PSI and PS2 over time when no crack;

FIG. 30 shows a graph showing measured data from PS1 and PS2 over time when a crack;

FIG. 31 illustrates a fifth exemplary embodiment of a crack detector, comprising a relative humidity sensors RH1 and RH2 and humidity absorption means in the sealed volume;

FIG. 32 shows a graph showing measured data from RH1 and RH2 over time when no crack;

FIG. 33 shows a graph showing measured data from RH1 and RH2 over time when a crack;

FIG. 34 shows a schematical diagram, which represents the sixth exemplary embodiment of a crack detector of the present invention;

FIG. 35 illustrates a graph showing the heating cycles by providing electric pulses to the resistive heating element and a corresponding response form the pressure sensor connected or integral with the sealed volume;

FIG. 36 shows a graph indicative of one of the possible methods for assessing a normalized representation of the parameter N that can be used as a calculated indicator of the crack presence and/or its size;

FIG. 37 shows a graph showing a general relation between the size of the crack and parameter N;

FIGS. 38 and 39 illustrate a seventh exemplary embodiment of a crack detector of the present invention, comprising a crack detecting patch with transparent top and an array of indicators changing its color in presence of any of the elements available from the atmosphere outside of the one present in the sealed volumes when a crack provides for a passage and communication between closed volumes and thus providing for a visual detection of a crack and its position;

FIGS. 40 and 41 shows sectional views of an eighth exemplary embodiment of a crack detector of the present invention;

FIG. 42 shows a block-diagram of the crack detecting device with an MCU and interface;

FIG. 43 illustrates the actual pressure-time diagram of the response to the fixed length heating cycle for a fixed length crack affected by different stress levels in aluminum alloy 7075-T6;

FIG. 44 shows the geometry of the coupon made of Aluminum alloy 7075-T6 with the crack grown from a concentrator hole and the direction of strains affecting it during crack monitoring process, and

FIG. 45 illustrated the monitoring process where N values are taken and assessed over the time.

### DETAILED DESCRIPTION OF THE INVENTION

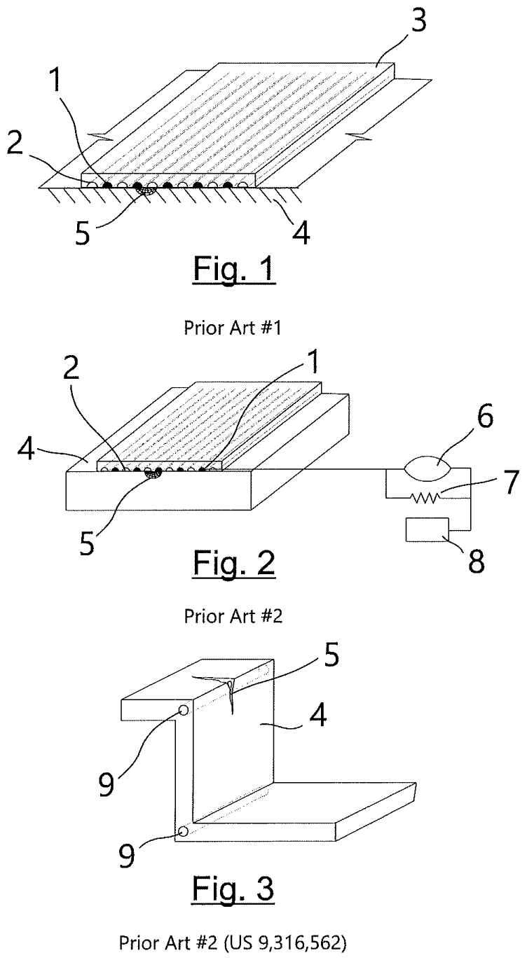

FIGS. 1 and 2 illustrate prior art related to comparative vacuum monitoring system where surface of the material 4 subject to crack 5 is equipped with a patch 3 containing galleries 1 and 2 sealed against the surface. Applying vacuum to one set of galleries (1) and comparing the value of the vacuum with some pre-set characteristic, or comparing it with pressure in the second set of galleries (2), one can derive the notion of a crack if the vacuum in the gallery cannot be kept stable.

A differential pressure sensor 6 combined in parallel with diffuser 7 and enabled by the vacuum pump 8 are further disclosed.

Another approach previously proposed by U.S. Pat. No. 9,316,562 is illustrated in FIG. 3, whereby the channels 9 is provided directly in the material 4 where pressure or vacuum applied can be monitored for its stability over time if there is no presence of a crack and instability if there is a presence of a crack 5.

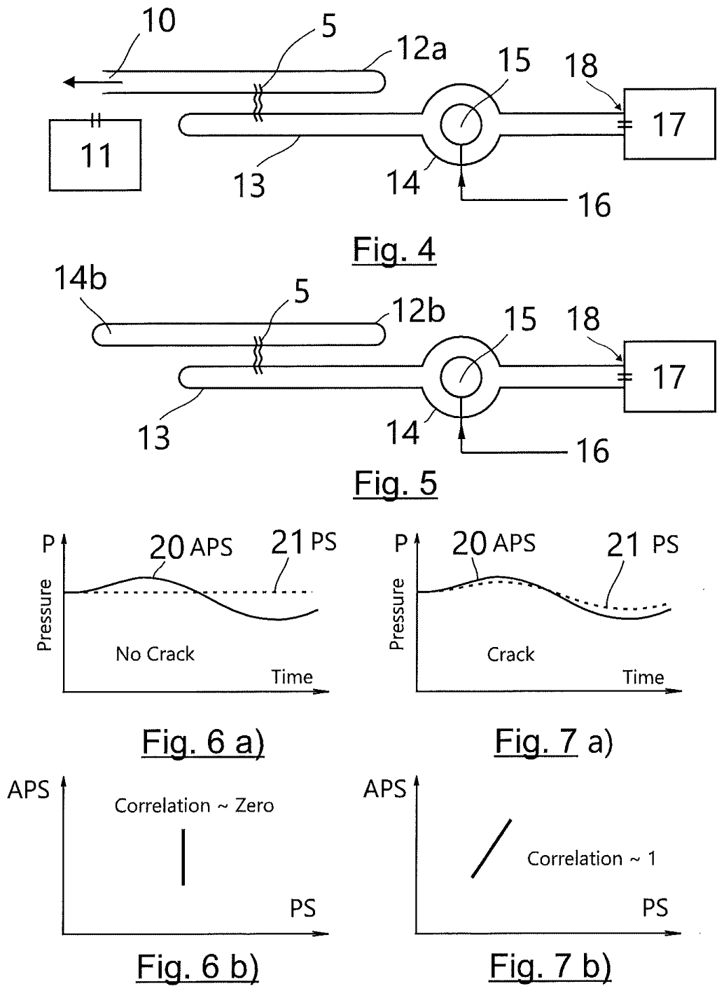

A schematic diagram of a first embodiment of a crack sensor 100 according to the present invention is illustrated in FIG. 4. A sealed or closed volume 14 associated with extension 13 of the volume 14 is provided on or in a material subject of a potential crack 5 and is positioned next to the potential crack 5. The volume 14 is in communication with an internal pressure sensor 17 through a port 18. The internal pressure sensor 17, in the simplest mode of operation, monitors pressure change inside the volume 14 and the extension 13 (in a form of, for example, channel, groove, bore, etc. associated with either surface of the material 4 or in the material itself). A passage/channel 12a may be provided adjacent to the volume 14 or/and the extension 13. The channel 12a may be open ended at a distal end 10 or may have an opening therealong, and is in communication with atmosphere.

Alternatively, a second passage/channel 12b may be provided adjacent to the volume 14 or/and the extension 13 as shown in FIG. 5. The channel 12b may be sealed/closed, defining a second sealed/closed volume 14b.

Referring to FIGS. 4 and 5, in a case of the crack 5 interrupting integrity of said volume 14 and/or the extension 13, the behavior of the readings at the internal pressure sensor 17 will change from only being dependent (or highly correlated with) on the temperature (Gay Lussac's Law states that the pressure of a given amount of gas held at constant volume is directly proportional to the Kelvin temperature) to be dependent on other parameters, for instance atmospheric pressure measured by pressure sensor 11. In other words, the crack 5 provides for the closed volume 14 becoming in communication with the atmosphere as shown in FIG. 4, or in communication with the second sealed/closed volume 14b as shown in FIG. 5. More precisely, if the volume 14 contains a fluid different from atmosphere as shown in FIG. 4 or from a fluid in the closed volume 12b in FIG. 5, another fluid other than the fluid inside the volume 14 may be introduced via the crack 5.

These variable conditions can be easily detected as shown in FIG. 6a) and FIG. 6b). FIG. 7a) and FIG. 7b). FIG. 6a) is a graph illustrating pressure measurements at atmospheric pressure sensor 11 and at the internal pressure sensor 17, and showing that in the absence of a crack affecting the volume 14/extension 13 and with constant temperature, the pressure (PS) derived from the internal pressure sensor 17 will remain stable even if atmospheric pressure (APS) measured by atmospheric pressure sensor 11 is changing over the time. Furthermore, as shown in FIG. 6b), the correlation between two pressures PS and ASP will be close to zero.

Contrary, if a crack is present and provides a microscopic channel allowing volume 14 to communicate with the atmosphere, the two pressures APS and PS will be correlated (as shown in FIG. 7a), and FIG. 7b)). In essence, by simply observing the physical conditions (pressure, humidity, or a chemical composition, etc.) of a closed volume 14, one can derive a reliable information about presence or absence of a crack and its relative size. Thus, the present invention provides for a solid-state crack detection apparatus, which, in its minimalistic approach does not require any pumps, moving parts and can be extremely portable and low power consuming.

Although this methodology is valid, the time needed for the assessment of the above correlations can be quite long and will depend on the magnitude of the atmospheric pressure change. In order to promote a quicker assessment, an exciter 15 of any of the internal physical or chemical properties can optionally be introduced in the closed volume 14 or in the extension 13. For instance, by heating the fluid contained in the volume 14, its pressure can be raised very rapidly and the observation of the pressure sensor 17 readings can be used in order to detect a crack and assess its relative size. The exciter 15 may be controlled by a controller 16.

If the communication between the volume 14/the extension 13 and the atmosphere (i.e., FIG. 4) is not desirable, a closed system described in FIG. 5 can be used. In this case a second fluid filling the second volume 14b and a first fluid (which may be different from the second fluid) filling the volume 14 will interact, if or when a crack is present. In purely pressure driven observations the additional volume of the second volume 14b will be added to the volume 14 and the extension 13, thus allowing for first fluid to be in communication with second fluid. Pressure would raise due to heat and the level of pressure rise due to excitation in the volume 14 will be affected by presence of the volume 14b, and the difference can be measured and compared with a condition indicating presence of the crack.

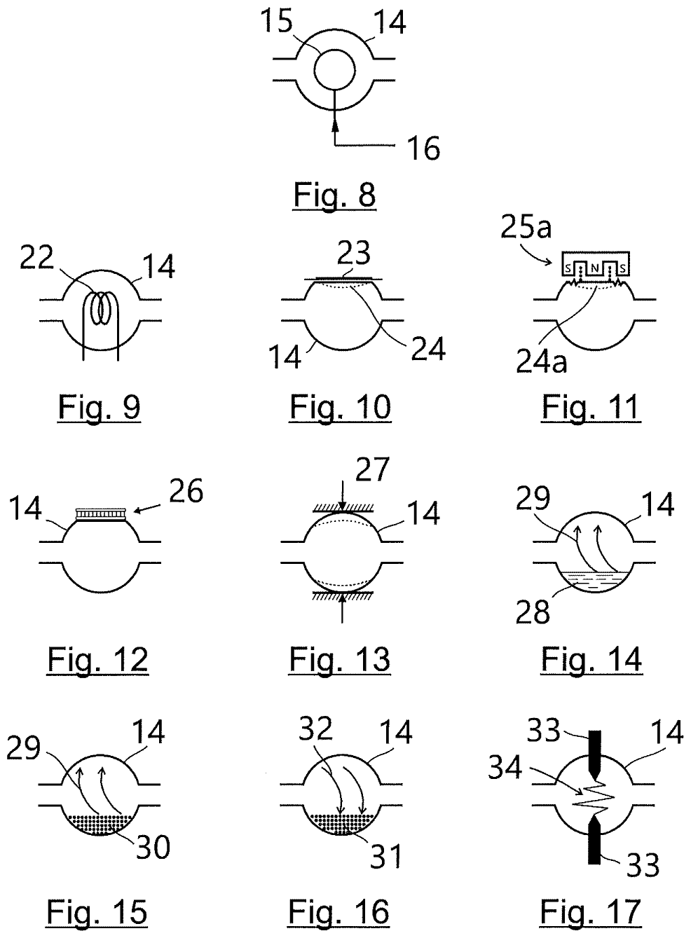

FIGS. 8 to 17 further illustrate different embodiments of the exciter 15 (or excitation devices) for using change of temperature, volume itself or using processes of absorption, sublimation or evaporation to achieve the same objective, i.e., to promote a change of the environment of the closed volume 14 and observe the effects of the change for two different conditions, including i. no crack (the volume is sealed and hermetic; and, ii. presence of the crack (the volume is not sealed and not hermetic). Such methods and devices used for excitation of the conditions can be controlled by a controller 16 which in turn can communicate with an MCU or a processor via serial or parallel bus.

In case of a resistive heater 22 shown in FIG. 9, for instance, the controller 16 can be an electronic circuit providing an electric pulse of a pre-determined duration and intensity.

According to another embodiment of the present invention, the volume 14 may be excited by use of a Piezo-electric membrane 24/actuator 23, where the Piezo-actuator 23 bends the membrane 24 to excite the volume 14 as shown in FIG. 10.

According to yet another embodiment of the present invention, the volume 14 may be excited by use of an electro-magnetic coil actuator 25a, similar to ones used in audio applications, such as earphones/speakers. For example, the electro-magnetic coil 25a actuates the membrane 24a to change the volume 14 as shown in FIG. 11.

According to further embodiment of the present invention, the volume 14 may be excited by use of Peltier cooler, heater, or thermoelectric heat pump 26, where heating would increase pressure and cooling the volume 14 would decrease pressure within the volume 14, as shown in FIG. 12.

According to yet further embodiment of the present invention, the volume 14 may be excited by use of means 27 to deform the shape thereof as shown in FIG. 13.

According to yet another embodiment of the present invention, the volume 14 may contain a liquid 28 which may evaporate/condense in an operational temperature range of the sensor to excite the volume 14 as shown in FIG. 14.

According to yet another embodiment of the present invention, the volume 14 may contain a sublimating material 30, which produces a gas or a vapor in an operational temperature range of the sensor to excite the volume 14 as shown in FIG. 15.

According to yet another embodiment of the present invention, the volume 14 may contain a moisture absorption material 31 for absorbing moisture 32 within the volume 14 as shown in FIG. 16. The moisture absorption material 31 may work as a hysteresis/buffer for avoiding false detection of the crack (when pressure/moisture is monitored to detect the crack), as detection of a crack formation may occur only after that the moisture absorption material 31 become saturated. According to yet another embodiment of the present invention, the volume 14 may be monitored or/and excited by use of electric discharge. For example, referring to FIG. 17, anode 33 and cathode 34 are provided in the volume 14 with electric discharge 34, and monitor the release/transmission of electricity in the fluid in the volume 14 to detect a presence of a crack.

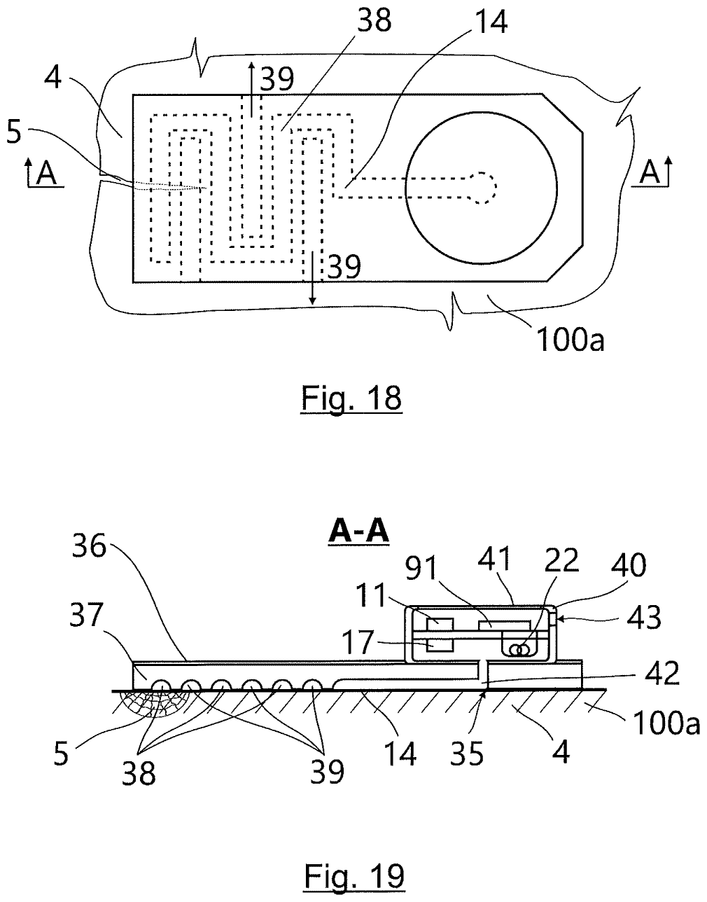

A crack sensor 100a according to one embodiment of the present invention is illustrated by FIG. 18 and FIG. 19, where FIG. 18 is a top view and FIG. 19 is a cross-sectional view at A-A of FIG. 18. Here, the material 4 can be affected by a crack 5 affecting its surface 35. The crack detector 100a comprises a housing 40, and a base or patch 37 made of a transparent pressure sensitive film and can have a transparent cover 36, both to facilitate visual observation or inspection of the surface 35 affected by the crack 5. One continuous groove or gallery 38 is provided on a bottom side of the base 37 interfacing with the material 4. The groove 38 may be formed by machining, mechanical or chemical etching, engraving (for example, laser engraving), casting, injection moulding or other means of forming it. The base 37 is attached to material 4 and the groove 38 of the base interfaces with the material, forming sealed volume communicating with the interior volume of the housing 40 via port 42 thus providing for a closed volume 14. The closed volume 14 may be filled with a first fluid, including a gas or a liquid. An internal pressure sensor 17 can be positioned within the volume 14, in the housing 40 which is in communication with the volume 14 or outside via a pressure conduit 43 which is in communication with the volume 14. A resistive heating element 22 is also sealed within the housing 40 or closed volume 14 or, alternatively can be positioned inside an additional volume communicating with said housing 40 or the closed volume 14. Interlaced with grooves 38 there are grooves 39 leading to and in communication with the atmosphere.

When the electric resistive heater 22 is activated the pressure inside the closed volume 14, which is formed by grooves 38, port 42, interior of the housing 40 and any external pressure conduits or other sealed volumes, raises. In the presence of heat applied to the first fluid inside said volume 14 and given thermal equilibrium, the pressure inside the volume 14 will remain constant. If a crack does intercept the sealed galleries 38 and provides for its communication with the atmosphere, it would cause the pressure to be gradually reduced. When the heating pulse applied by the resistive heater 22 is removed and the temperature inside the volume 14 returns to its original value, the pressure will drop and, if some fluid already exited the volume 14, the pressure at the original temperature will be different from its originally measured value (as determined before applying the heat pulse). Then, after the fluid will reverse its direction and re-enter volume 14 again through the crack, it may bring its pressure back to a similar value observed at the beginning of the cycle as illustrated in FIG. 43.

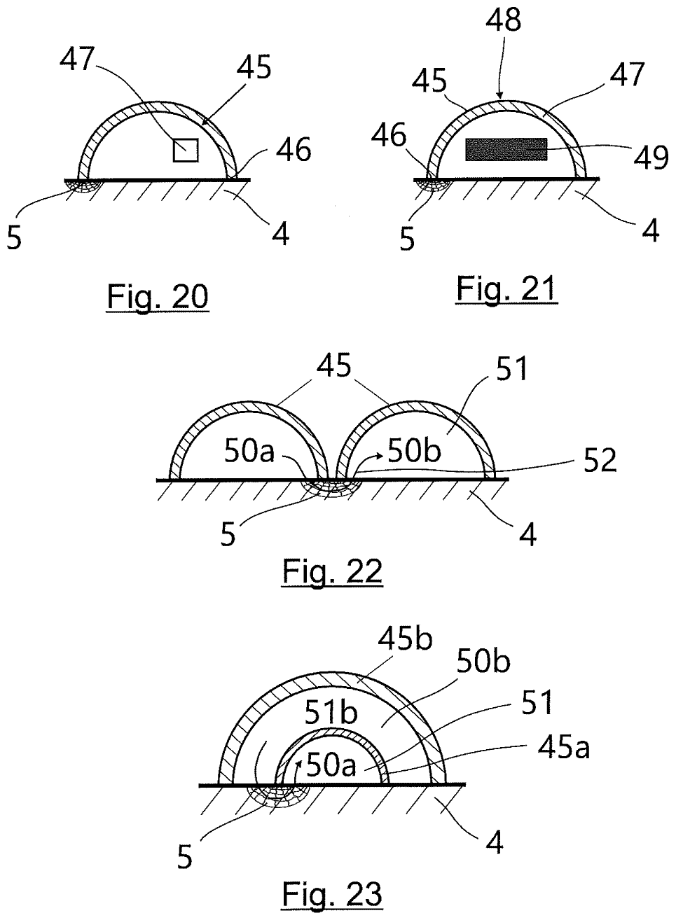

There are different configurations where a sealed volume 14 can be created. FIG. 20 shows a closed volume 14 is defined as an individual cell 45 with hermetic seal 46 over the surface of a material 4 subject of a potential crack 5. Any sensor or sensors 47 can be positioned within the cell 45 without compromising its hermetical seal (it should be understood that the controls needed for sensor/s 47, power and communication lines have to be hermetically sealed as well). In this embodiment, the sensor 47 may be selected from the group consisting of a pressure sensor, relative humidity sensor, and gas detector.

It is desirable to have the material of such cell 45 made transparent for allowing visual confirmation/observation of the material 4.

In addition to sensors 47, or independent of it an indicator 49 can be positioned within the cell 47. Such an indicator 49 can have a change of color, or dielectric property for instance, in reaction to change in the internal physical or chemical condition of the volume 14 comprising cell 47 when a fluid form outside of the cell 47 enters its interior via a crack 5. One example is a simple moisture indicator placed inside cell 47 where, at installation the moisture from the cell 47 is removed. For example, when a crack appears and compromised the sealed/closed volume defined between the cell and the material 4, the moisture from the fluid (air, for instance) surrounding the cell 47 enters inside the closed volume and changes the color of the indicator 49. Thus, an individual cell 47 becomes a passive indicator of a crack.

Needless to say, that such individual cells can be arranged in different shapes and manners, including forming lattices, patterns and matrices strategically designed to assist in intercepting the cracks and more precise visualization of such as would be shown in FIGS. 24, 25 and 26.

If reliance on atmospheric moisture or gas content as means to induce the reaction of the indicator 49 is not desired (for instance, the crack detector's positioning on an unprotected material surface where its contact with atmosphere shall be prevented), then adjacent cells 45 can be provided, where the two adjacent cells 45 contain different from each other fluids 50a, 50b. When a crack 5 forms, such crack will become a conduit 52 to allow pass different fluid(s) through the crack 5/conduit 52 and thus providing for a measurable change as shown in FIG. 22. One of the closed volumes formed between two adjacent cells 45 and the material 4 can be designated as a sensing volume 51.

Yet another configuration can be achieved as shown in FIG. 23, where one cell 45a forms a sensing volume 51 with a fluid 50a, which is, then, surrounded by another cell 45b forming a surrounding volume 51b containing a different fluid 50b. Yet, merely providing an additional volume filled with any fluid 50b will increase the total volume of the sensing volume 51, which can be used to identify a crack 5 by using a sensor positioned within the sensing volume 51.

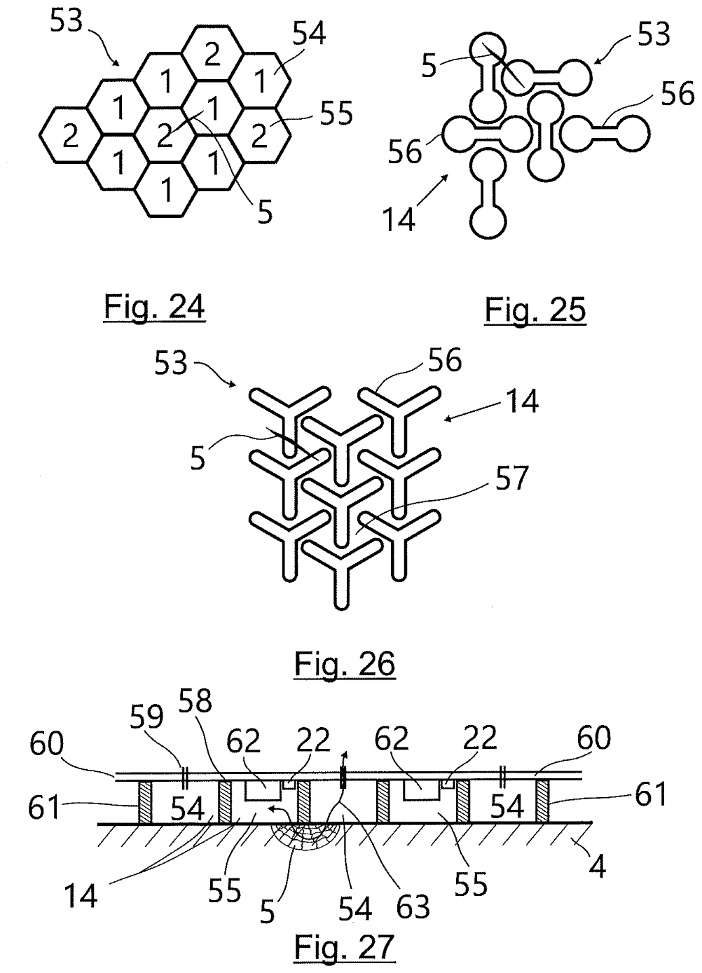

In case of repetitive patterns or lattices 53 illustrated in FIGS. 24-25, for example, the pattern 53 shown in FIG. 24 employs and illustrates the same principle shown in FIG. 22, where sensing cells 55 are surrounded by cells 54 containing a different fluid (not shown) from one contained in the sensing sells 55.

The pattern 53 with sensing cells 56 shown in FIGS. 25 may employ the same principles shown in FIGS. 20, 21, and 23.

The repetitive patterns or lattices 53 illustrated in FIGS. 24-25 can be applied where an environment surrounding the sensing cells or volumes 55 can contain either the same or different fluids or be simply exposed to the atmosphere. The purpose of the lattices' individual cell geometry and orientation remains to provide for a structure where any direction of a possible crack propagation will be intercepted.

A practical device incorporation such crack detecting lattice is shown in FIG. 27 (elevation). The vertical walls 61 are providing for divisions between the adjacent cells 54 (honeycomb matrices, for instance, shown in FIG. 24), sensing cells 55 are equipped with a pressure, relative humidity, chemical content, temperature, etc. sensors 62; the sensors 62 and heating elements 22 (or any other means devised to promote a change of the environment inside a close volume 14) can be mounted on a printed circuit board (PCB) 60 serving as a cover providing hermetic seal to all cells, and together with walls 61 and the surface of the material 4 forming the closed/sealed volumes 14. If communication with atmosphere is desired, the PCB 60 can have openings 59. Accordingly, when a crack 5 provides for a passage or a path 63 for inter-communication between adjacent cells, the properties of the fluids filling them change and allow for crack detection.

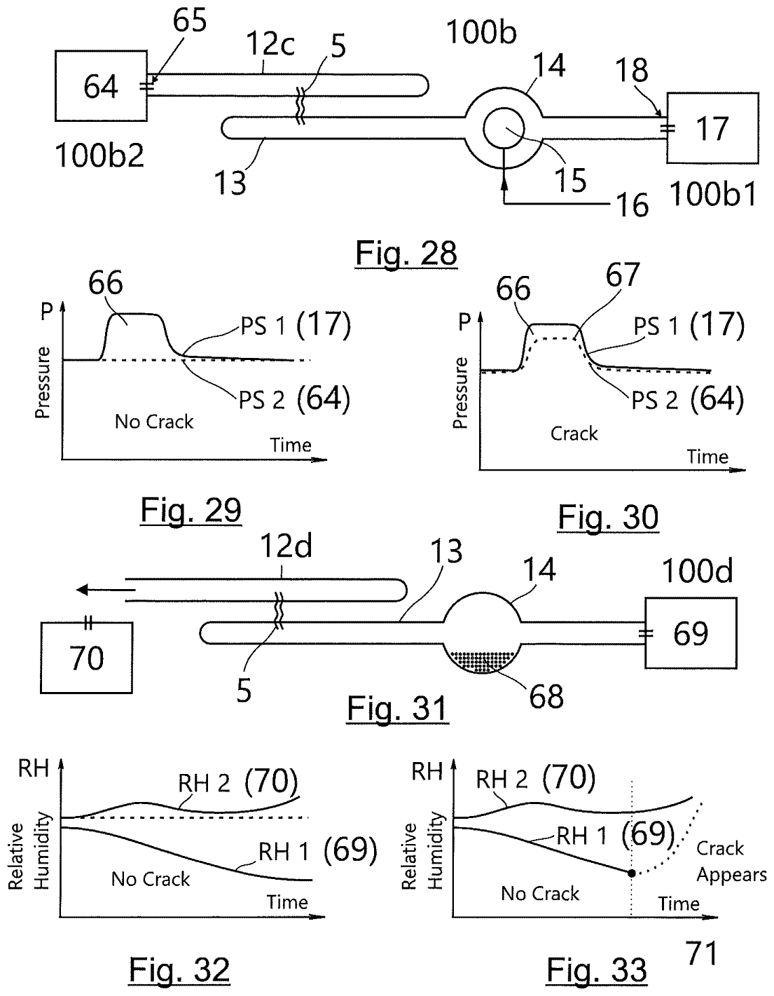

A crack detector 100b according to another embodiment of the present invention is illustrated in FIG. 28, wherein the crack detector 100b comprising a first cell 100b1 and a second cell 100b2. The first cell 100b1 having a first pressure sensor 17 in communication with a sealed volume 14 with a extension 13 through a port 18; and, the second cell 100b2 having a second pressure sensor 64 in communication with a second closed volume 12c through a second port 65. The first cell 100b1 optionally includes a condition exciter 15. The arrangement described here represents a close system, where a crack does not provide communication of any of such volumes with atmosphere. This configuration can be useful for applications where a material 4 is submersed, or any exposure of its surface to the outside environment is prohibited.

FIG. 29 is a graph of pressure measurements by the first and second pressure sensors 17 and 64, illustrating the difference in the pressure values reading by the first pressure sensor 17 and the second pressure sensor 64 during the pressure excitation cycle 66 of the volume 14, while no crack is present. In the absence of a crack the second pressure sensor 64 does not react to a change of pressure as read by the first pressure sensor 17. In other words, both volumes remain isolated. In case of a crack as shown in FIG. 30, the fluid passes between volume 14a and volume 12c through the crack 5 and this process causes the pressure of the fluid in volume 12c to increase as measured by the second sensor 64.

It has to be noted, that the amount of the pressure rise can be as low as 5-15 hPa and this pressure increase does not cause any significant deformation of the volume, as well as it does not cause any possibility of the seals to become compromised. It is of course understood, that the higher the pressure difference is, the faster an assessment of the crack can be completed. With the above pressure differences (5-15 hPa) and in order to identify a very small crack the time required for the assessment can run somewhere between 5 to 30 minutes.

Now, turning to use of other than pressure sensing means, let's look at the example of relative humidity sensor. FIG. 31 shows a crack detector 100d according to yet another embodiment of the present invention, where a relative humidity sensor (or RH sensor) 69 is positioned to monitor the relative humidity of the volume 14. In the absence of a crack, the RH sensor 69 will provide a fairly steady readings regardless of the level of moisture in the ambient atmosphere, which may be monitored by a second relative humidity sensor (or second RH sensor) 70, surrounding the crack detector 100d and represented by a channel 12d open to the atmosphere. Optionally, humidity/moisture absorbent material 68, such as silica gel, calcium chloride, etc., may be disposed in the volume 14. To illustrate it in simpler terms one may envision a tightly corked bottle where the inner environment remains unchanged. Any crack, regardless of its size, will compromise this environment causing it to get closer to the environment surrounding such bottle.

If the second relative humidity sensor 70 is monitoring the outside environment, it is possible to analyse the correlation between the two and derive information assisting in identification of a crack as illustrated by FIG. 32 and FIG. 33, respectfully.

As it is very difficult to assure absence of any moisture during the installation process of the crack detector, it is desirable to include a certain amount of moisture absorbing material in the volume 14. After some time, the initial amount of the moisture trapped inside the volume 14 will be absorbed by the absorbent 68 and the relative humidity sensor 69 readings will fall close to zero percent. As the crack with provide the unlimited amount of moisture to diffuse and enter into the volume 14 over the time, the moisture absorbent 68 will be eventually saturated and the sensor 69 readings will start raising, exceeding a certain threshold in case of use of a single sensor 69 or settling around the average value of the relative humidity measured by sensor 70.

It is important to mention that the same principle can be applied to sensing other parameters, for instance an amount of Oxygen, Nitrogen, CO₂, etc. that can pass into the volume 14 via the crack. Alternatively, if an adjacent volume contains second fluid and not simply any of the components of the atmosphere, sensing the presence of such fluid entering volume 14 will also provide for the same result of crack detection.

Yet, another option is to observe a chemical reaction occurring when the fluid from volume 14 mixes with the fluid outside of the volume 14.

Obviously, the same methodology can be further enhanced by using electronic indicators, change of material properties and any other means for identifying the fact of the volume 14 becoming not hermetic due to a crack. Those means can include, for instance, change in dielectric constant, resistivity, vibrational patterns of a micro-electro mechanical system and use of any other methods that can help in identification of a change of either physical or chemical state of the fluid filling volume 14.

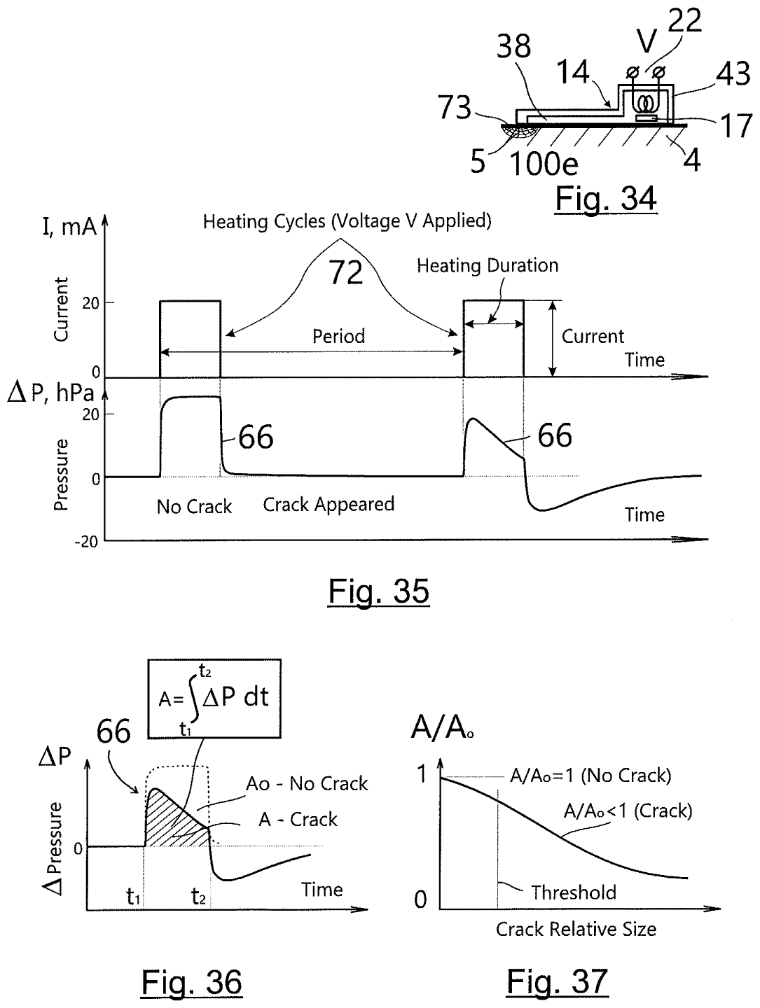

FIG. 34 is a crack detector 100e according to yet another embodiment of the present invention and corresponding with the devices also shown in FIGS. 18 and 19. The crack detector 100e forms a closed volume 14 positioned over a surface 73 of the material 4 and having an extension in a form of a channel 38, which may have different geometrical shape or a pattern in order to be able to be intercepted by a crack. A resistive heater 43 provides for a pulse of heat causing changes in pressure, which is being measured and monitored by the pressure sensor 17.

FIG. 35 shows the time diagram of the electric pulses providing for heating and corresponding change in the pressure read by the sensor 17.

As the crack 5 appears and progresses the magnitude of the pressure change reduces as the fluid (such as gas/air) from the volume 14 escapes through the crack 5. One simple method and algorithm for the assessment is to integrate the pressure values as read by sensor 17 over the time and derive a parameter N=A/I/V, where A is the integral area of the pressure plot, I—current passed through the resistive heater and V—voltage applied during the heating pulse. The method is illustrated by the FIG. 36. The parameter N will gradually reduce as the crack becomes larger.

It has to be noted that the method presented above is just one out of many that can be used. One may envision that having multiple input parameters a variety of sensing means employed can assure that the machine learning and artificial intelligence methodologies will be quite applicable not only in identification and characterization of a crack, but also in filtering out, compensating for or canceling the parameters which are obscuring the accuracy of crack detection process, as well as it will be useful in providing algorithms aimed at compensation of effects of temperature, stresses the material around the crack is experiencing, and other factors.

FIG. 38 shows a schematic view of a passive crack detector 53 according to yet another embodiment of the present invention. The crack detector 53 comprises a patch 74 adhered to the surface of the material. The patch 74 has a plurality of sealed cavities 75.

FIG. 39 is a cross-sectional view at A-A in FIG. 38. The base with cells 76 and the surface of the material 4 define cavities 75. Any or all cavities 75 may have an indicator reacting with the fluid or gas entering the cavity via a crack 5. The indicator can, for instance, change its color when such a reaction occurs. Then, the plurality of such cavities will constitute as a passive visual indicator for detecting a crack, given the cover 77 of the patch 74 is transparent, where each individual cavity will constitute a pixel of the display. Thus, a crack will leave a permanent trace of a different color indicator allowing not only for a detection of a crack, but also identification of its progression. Needles to say, that one simple indicator can be moisture indicator or Oxygen indicator and an appropriate gas/fluid absorbing material can be used to reset the crack detector 53 to the desired state after the installation.

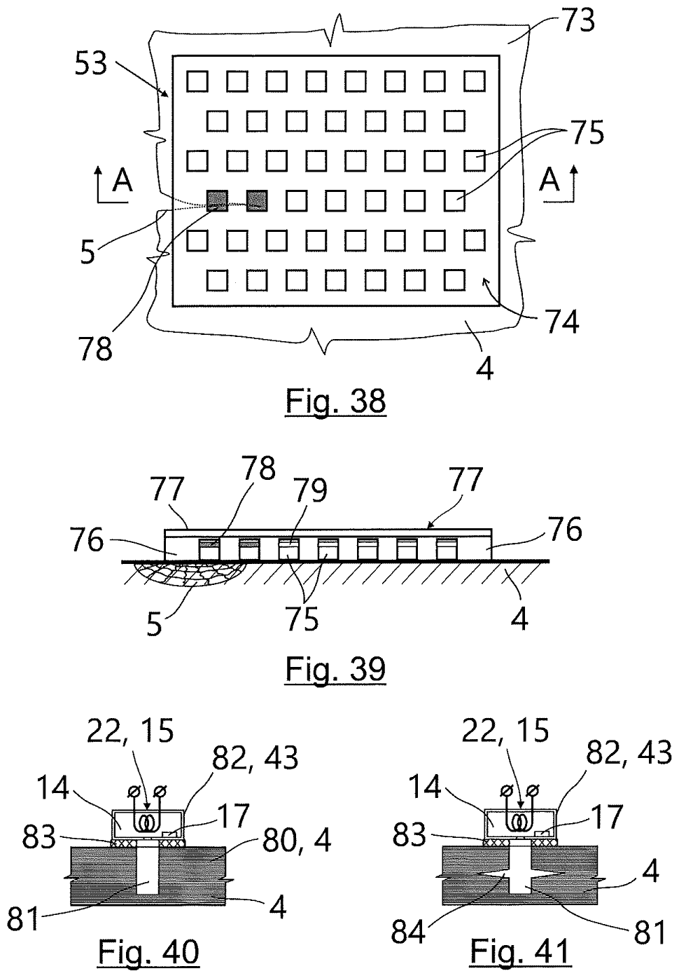

Lastly, cross-sectional views of a crack detector 100f according to yet another embodiment of the present invention are shown in FIGS. 40 and 41. The crack detector 100f with volume 14 and its extension in the form of a blind bore 81 protruding into the thickness of the material 4 (a composite, for instance) provides for periodic heating pulses using heater 22 and sensing pressure in the closed volume comprised from the inner volume 14 of the housing 82 and the inner volume of the bore 81. When a delamination 84 happens, the combined volume of volume 14 and volume 81 increase and is grater that the initial combined volume. Thus, given the heat input during the heating pulse delivered by the heater 22 remains the same, the raise of the pressure being monitored by pressure sensor 17 is lower that the raise of the pressure in the unaffected by the delamination configuration. That provides for a possibility of detecting an inner crack caused by the delamination even though the delamination itself may not lead to an opening of the affected by the delamination area to the atmosphere.

Thus, present invention can be also useful in identification, characterization and monitoring of not only cracks, but also voids, debonding between parts or between protective covers and paints. In summary, the methodology described can be applied to detection and monitoring of any voids, that may be caused by the usage of the material during the life of any structure.

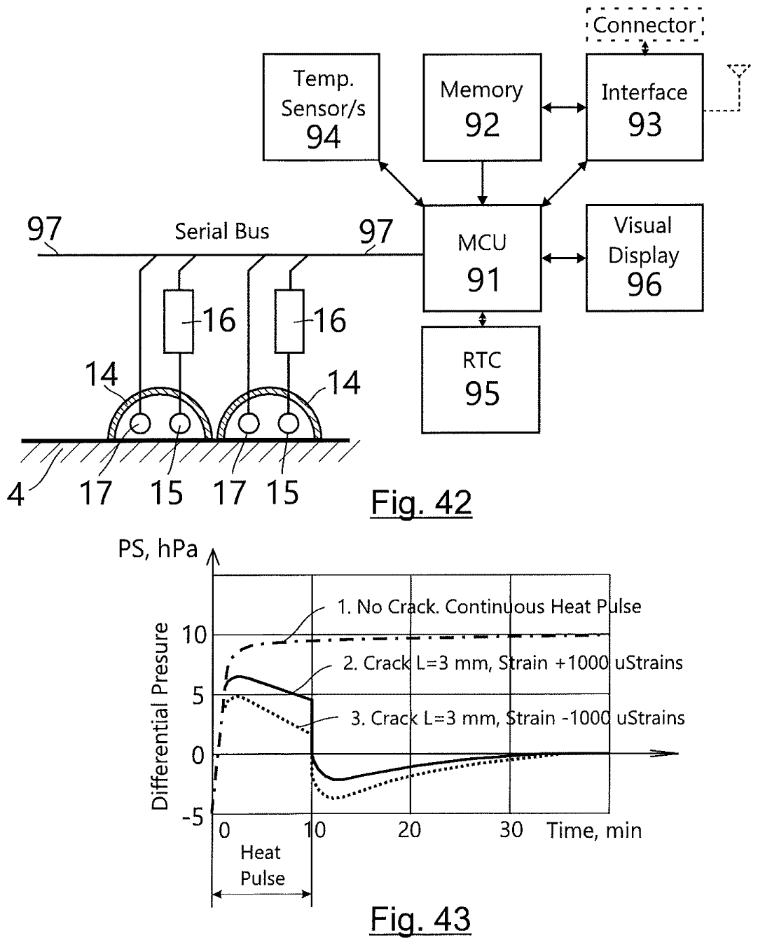

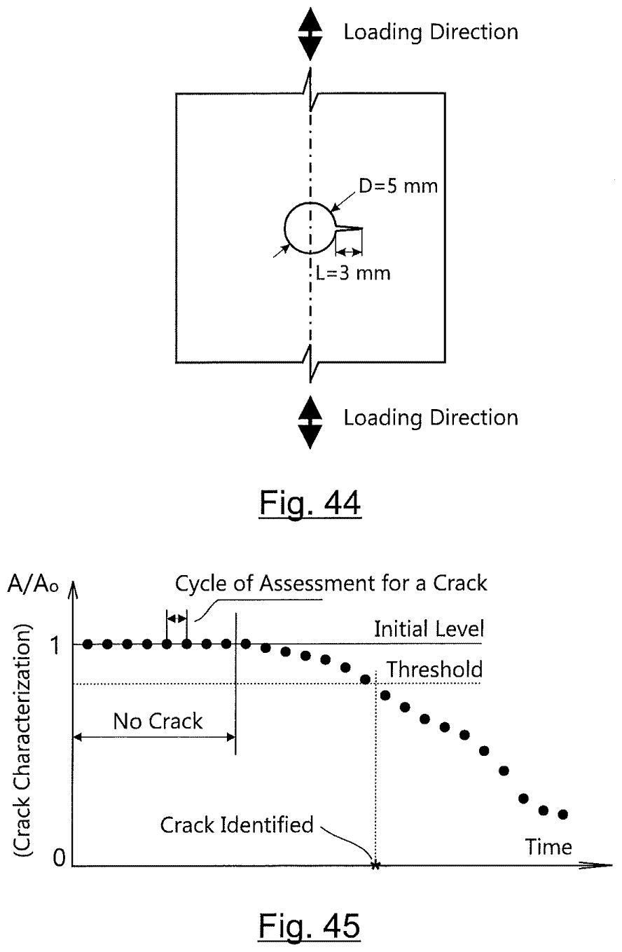

FIG. 42 shows the block-diagram of one possible configuration of the present invention. It includes an MCU or a processor 91, memory 92, interface 93 (UART, I2C, CAN, RS485, etc.), temperature sensor 94, real time clock (RTC) 95, visual means for displaying information on the crack presence, absence and relative size (LED indicator, display, etc.), serial or parallel bus or buses for communication with sensing means, pressure sensors 17, for instance, control circuits 16 and exciters 15. The system can communicate with external data management system, network of sensors, monitors, wireless communication means, etc., generally denoted as external monitoring system 98.

FIG. 43 illustrates the pressure response to a heat pulse applied for 10 minutes for the following conditions:
1. No crack. The pressure PS remains stable. If the heating pulse is terminated at 10 minutes, the pressure PS falls to zero. If the heat pulse continues, the pressure remains stable.
2. Crack of 3 mm long. Positive strains +1000 μstrains, tension.
3. Crack of 3 mm long. Positive strains +500 μstrains, tension.
4. Crack of 3 mm long. Negative strains −1000 μstrains, compression.

As seen from the diagram the fall of the pressure becomes more apparent with crack being under tension, which causes the crack to open wider and pass more air from the volume 14 during the heating cycle. Accordingly, after the heating pulse is removed, the pressure PS falls under the original value (for simplicity, the original pressure PS is signified as zero, although it is close to 1000 hPa).

FIG. 45 schematically illustrates the geometry of the coupon with crack grown on a side of a hole (concentrator) in the plate made from Aluminum alloy.

Both illustrations indicate the importance of knowing the level of strains/stresses under which the measurement of pressure and assessment of the crack size is made. Thus, a combination of the present invention and the device described in the U.S. Pat. No. 10,663,357 or alike and capable of simultaneous monitoring of strains in the area of the crack is desirable. It should be apparent for one skilled in the art that knowing the relationship between crack relative size, strains/stresses and the output of the present crack detector the accuracy of the crack size characterization can be significantly enhanced.

Finally, the FIG. 45 shows the process of the assessment for the crack and its progression based on series of N-value measurements. Here No is the value, which may be derived and established based on observations of N-values over the time and with no crack condition. Accordingly, a threshold can be established and when N-values are crossing it, the condition of crack can be determined. It must be noted that as described before, some variation of the N-values will be related to strain/stress condition the material is under.

For determination of the cracks, the values measured by the sensors may be compared with anticipated, predicted, measured or calculated values for detecting a presence of crack using a comparator or a processor.

There are many variants of the proposed configurations with the following features and means, including, but not limited to:
1. Acid or base can be used as a fluid for volumes surrounding the sensing volume or cell;
2. Sterile (sterility) indicators can be used to detect presence of Oxygen, for instance and serve as visual indicators;
3. Wireless system can be used to communicate with the crack detector for monitoring cracks remotely;
4. Battery operated system can be used for autonomous operation;
5. Energy harvesting can be used to power the system or assist in powering;
6. Each cell or closed volume arranged in a lattice can have an LED or a passive display type means (e-paper, for instance) for assisting visualization of the crack position and propagation;
7. UV resettable indicators sensitive to gases or moisture can be used;
8. Heat resettable indicators sensitive to gases or moisture can be used;
9. Diffusors can be used to release pressure in a controllable way or to equalize pressure between ambient environment, adjacent to the closed volume cells, or a combination thereof;
10. The crack detector can be provided in a form of a label or a patch equipped with pressure sensitive adhesive, with or without protective cover;
11. Customized shapes to conform to the variety of parts and surfaces can be provided;
12. Electronic circuit can be integral with the device or the label/patch, or it can be housed separately;
13. Patterns and lattices of all sorts can be employed;
14. Sealing the material surface or the entire label/patch with paint or transparent sealant can be provided to assist in observing crack details during installation process;
15. Serially, in parallel (or any combination thereof) connected volumes or channels in conjunction with at least one pressure sensor can be used to assess the progression of the crack and, optionally diffusers between said volumes can be employed to assist in assessment of the crack size and growth rate;
16. Independent volumes (cells), each equipped with pressure, relative humidity, and/or temperature sensors can be connected to an MCU using serial or parallel interface;
17. Artificial Intelligence and Machine Learning protocols can be deployed to assess the data produced by individual sensing means as well as the output information on crack presence, size and rate of progression;
18. Temperature sensor is a desirable component of the majority of the configurations described hereabove.
19. MEMS actuators can be used for volume change excitation.
20. Gas content and chemical analysis measurement can be used;
21. An oscillating mass equipped with an absorbent mass or sublimating mass can be used as a sensing mean by observing change in natural frequency of such oscillating mass;
22. Vaporization, phase change, sublimation can be deployed for effecting the change in the state of the fluid inside any volume;
23. Liquid leaving the volume due to evaporating via a crack and leaving dyed trace can be deployed; and
24. Ionized gas and change of electrical properties of such when ions escape via a crack can be further deployed.

Beside the above variants, it is clear that the foregoing embodiments of the invention are examples only and can be varied in many ways. Such present and future variations are not to be regarded as a departure from the spirit and scope of the invention, and all such modifications as would be obvious to one skilled in the art are intended to be included within the scope of the possible claims.

1. A crack detector for a material, comprising:
a. a base defining at least one sealed volume formed between the material subject of a potential crack in said material and the base, wherein the at least one said sealed volume is filled with a first fluid, and,
b. at least one first sensing means in communication with said at least one sealed volume,
wherein the at least one first sensing means measures a change in at least one physical or chemical parameter of the first fluid for detecting the presence of a crack.

2. The crack detector according to claim 1 further comprising a comparator for comparing said change in the said at least one physical or chemical parameter of the first fluid with a characterized physical or chemical parameter of said first fluid.

3. The crack detector according to claim 2, wherein said characterized parameter of said first fluid is anticipated, predicted, measured or calculated.

4. The crack detector according to claim 1 wherein said at least one sealed volume is surrounded by a second fluid.

5. The crack detector according to claim 4 further comprising at least one second sensing means measuring at least one physical or chemical parameter of said second fluid.

6. The crack detector according to claim 3 further comprising a means for inducing or changing a physical or chemical parameter of said first fluid.

7. The crack detector according to claim 4 wherein said first fluid is gas or liquid; and the second fluid is gas or liquid.

8. The crack detector according to claim 5, wherein said at least one first sensing means is configured to measure one or more of parameters selected from the group consisting of pressure, temperature, mass, chemical composition, presence or absence of a chemical substance or a gas, color, humidity or relative humidity, and any optical or electric property of said first fluid; wherein said electric property is selected from the group consisting of dielectric constant, resistance and capacitance.

9. The crack detector according to claim 8, wherein at least one said second sensing means is configured to measure one or more parameters selected from the group consisting of pressure, temperature, mass, chemical composition, presence or absence of a chemical substance or a gas, color, humidity or relative humidity, and any optical or electric property of said first fluid; wherein said electric property is selected from the group consisting of dielectric constant, resistance and capacitance.

10. The crack detector according to claim 9, wherein said first sensing means is configured to detect a chemical reaction, diffusion or dilution in said first or second fluid caused by said fluids becoming in contact with each other.

11. The crack detector according to claim 6, further comprising means for changing the amount of any component of said first fluid.

12. The crack detector according to claim 6, wherein said means for inducing or changing a physical or chemical parameter of said first fluid is changing its pressure and is selected from the group consisting of a heater and a cooler.

13. The crack detector according to claim 12, wherein said means for changing pressure of the first fluid comprising volume changing means by bending a diaphragm, moving a piston or deforming said volume itself.

14. The crack detector according to claim 11, wherein said means include an absorbing material for reduction of the presence of a predetermined gas or liquid.

15. The crack detector according to claim 4, wherein said at least one sealed volume comprise a plurality of compartments embedded in a sheet comprising transparent sections at least over said sealed volumes or compartments and wherein said plurality of compartments contain a visual indicator of presence or absence of said second fluid.

16. The crack detector according to claim 4, wherein said at least one sealed volume comprise a plurality of compartments embedded in a sheet comprising said at least one first sensing means to detect said second fluid entering said sealed volume or said first fluid exiting from said sealed volume.

17. The crack detector according to claim 1, wherein said sealed volumes comprise a plurality of compartments arranged in a matrix, pattern or lattice spread over said material.
